(19) United States
(12) Patent Application Publication
(10) Pub. No.: US 2010/0146594 A1
(43) Pub. Date: Jun. 10, 2010

(54) DATA NAVIGATION USING SET OF AUTHORISED FORUMS THROUGH INTERNET

(76) Inventor: Subrahmanya Satya Kari, Hyderabad (IN)

Correspondence Address: Kari Subrahmanya Satya, 16-11-405/20, SBI Officers Colony, Moosarambagh, Dilshuknagar,, Hyderabad, 500036, IN

(21) Appl. No.: 12/360,118

(22) Filed: Jan. 27, 2009

(30) Foreign Application Priority Data
Dec. 8, 2008 (IN) 3078/CHE/2008

(51) Int. Cl. G06F 21/20

(52) U.S. Cl. 726/4

(57) ABSTRACT

The present method relates to navigating data via a set of authorized forums. The method includes authenticating the website using an identifying module by a user. Further, the method includes viewing one of a set of authorized forum from the displayed set of authorized forums by the authenticated user. Furthermore, the method includes selecting one of the authorized forums by navigating the website by the authenticated user.

### TECHNICAL FIELD OF THE INVENTION

The present technique relates to navigating data via a set of authorized forums including authenticating the website using an identifying module and viewing one of the set of authorized forum from the displayed set of authorized forums.

### BACKGROUND OF THE INVENTION

In various applications, global hub is provided in a two-dimensional virtual world of a fixed configuration, in which wares are displayed in fixed arrangement. The global hub may be provided in a three-dimensional virtual world.

In many applications, wide spread use of the internet for online education has resulted in the need for specific and secure identification of a user, or client, who wishes to connect with a particular website server so that the user/client may access information which the user/client is authorized to obtain.

However, in such a configuration, global hub provides a method for maintaining a database of information and characteristics about a specific web site, particularly the web site of virtual university, to facilitate more secure authentication of selected web site and to protect against “phishing” and “pharming” attacks.

Conventional techniques suffer from two problems: such methods are designed to provide the end-user with a security warning within a standard, open web browser program, such as Microsoft Internet Explorer, Netscape, Mozilla Firefox, or the like. In many cases, end-users does not recognize or notice such security warnings when given. Additionally, such methods work within standard web browser programs. Standard web browser programs have open interfaces and are therefore vulnerable to malicious software plug-ins which can compromise an end-user's security.

The development addresses these and other shortcomings of conventional approaches. To address these problems, methods are described, that enable users to authenticate sources with which they wish to communicate, learn, social network, work and provide user authentication using an identifying module.

### SUMMARY OF THE INVENTION

The present technique provides a method for navigating data using a of authorized forums via a website. The method includes authenticating the website using an identifying module by a user. Further, the method includes viewing one of the set of authorized forums from the displayed set of authorized forums by the authenticated user. Furthermore, the method includes selecting one of the authorized forums by navigating the website by the authenticated user.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG.1 is a block diagram for navigating a set of authorized forums via a website;

FIG.2 is a flowchart illustrating a process of, authenticating the website using an identifying module in accordance with an aspect of the present invention; and

FIG.3 is a schematic illustration of a web tree for web site navigation according to an embodiment of the present invention.

### DETAILED DESCRIPTION OF THE INVENTION

The present technique provides a method for navigating data using a set of authorized forums via a website.

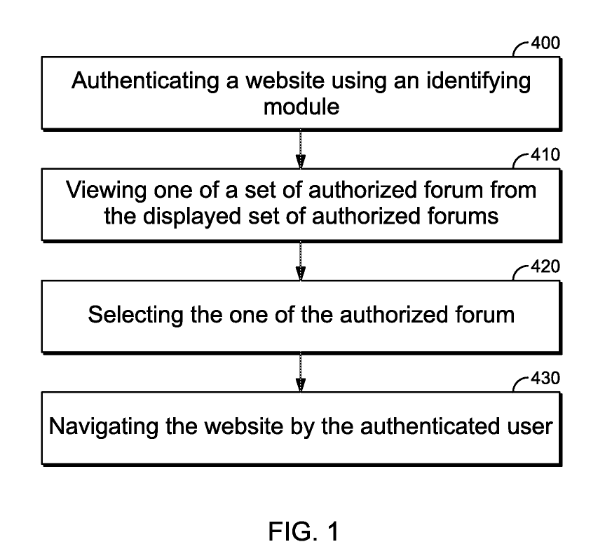

Referring to FIG.1, is a block diagram for navigating a set of authorized forums via a website. The process starts in block 400, where authentication of a website using an identifying module is done. The user enters the website by typing the website address. The website can be a virtual world or the like. The server machines and client machines are interconnected via a network such as the Internet, a telephone network or a local area network (LAN). In this embodiment, a global hub is supposed to be a global interface for all the institutions, work places or the like which are replicated electronically and are accessed.

Alternatively, the global hub may be described in a virtual two-dimensional, three-dimensional space or the like. Once the authentication is done, user is displayed with a set of authorized forums as in block 410 wherein the displayed set of the authorized forums includes an online innovation station or a translation forum or a hall of fame or a learning forum or a museum forum or an online social networking forum or an online notebook forum or an online assessment test forum or a research work forum or an entertainment forum or a shopping forum or a health section forum or the like or the combination thereof. User can navigate through the website by selecting at least one of the set of authorized forums. In block 420 selecting one of the authorized forums from a set of authorized forums are done. And in block 430 users navigates the website through the selected forum. A request option appears for the forums that are not authorized. If the user intends to access the unauthorized forums he sends a request to the server.

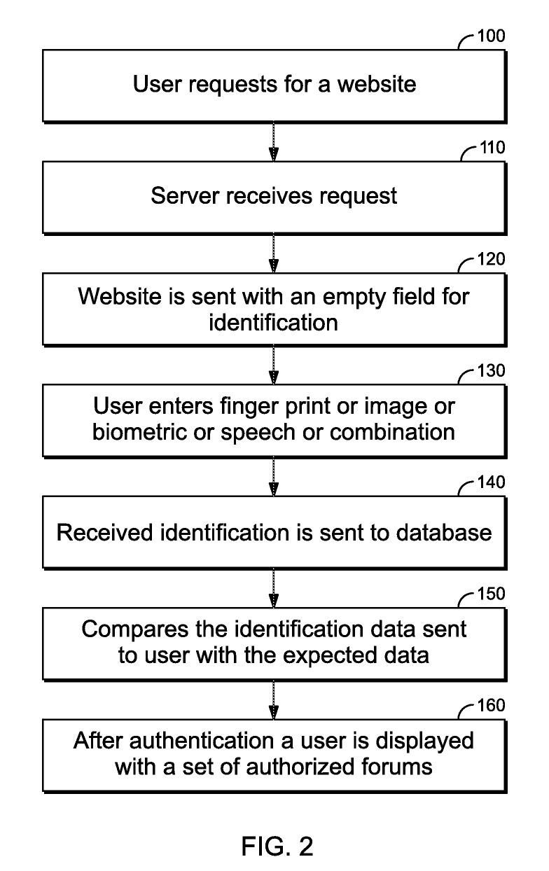

Referring to FIG. 2, is an example for an additional embodiment of the present invention. The process starts in block 100, when the user enters the website by typing the website address. In block 110 the request is received by the server and in block 120 the first page of the site is sent to the user with an empty field for identification. In block 130 the user receives the first page of the website with the empty field and he enters the client key, which can be an image or finger print or speech or biometric or a combination thereof or the like.

At step 140, the website receives the client key and accesses database. In block 150 the database compares the client key data sent by the user with expected data. If the received client key is different from the expected client key, the user receives a message to try again. In block 160 if the client key is identical to the key stored in the database, user is displayed with a set of authorized forums.

A set of authorized forum can be online innovation station forum, providing the student with innovation museums and young innovators challenge or the like. Translation forum provides the student with different languages to communicate with each other or the like. Hall of fame forum provides the students the names of people who acquired fame or the like. Learning forum provides the students learning through power point presentation, instant questioning, short videos files, audio files or the like. Museum forum provides the students with literary, scientific, art works of the people or the like. Online social network forum provides the students to write anything and no classifications involved or the like. Online notebook forum provides the students to maintain an online note and provide a possibility to share the information noted between each other or the like. Online assessment test forum helps to monitor the overall progress of the students or the like. Research work forum provides the students to maintain research work records of the people or the like.

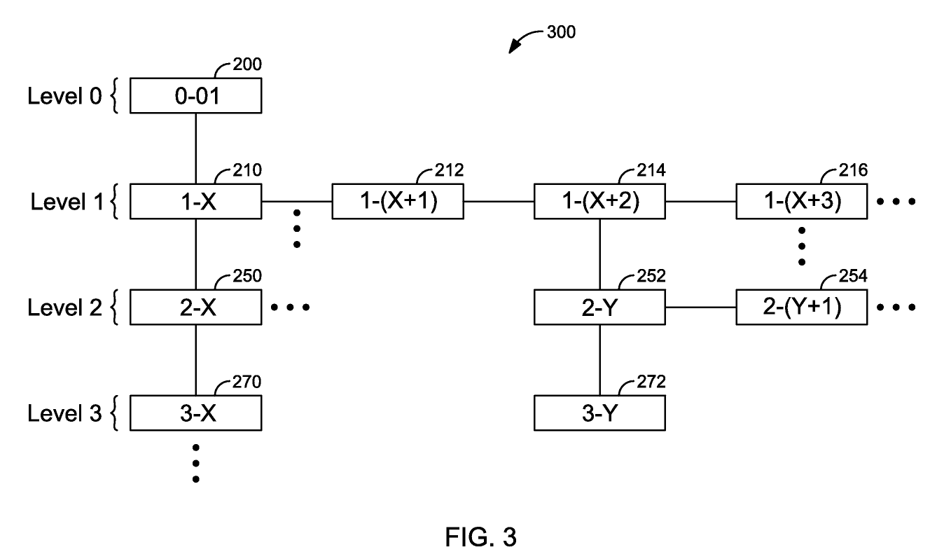

Referring to FIG. 3, is a schematic illustration of a web tree 300 for web site navigation according to an embodiment of the present invention. Box 200 is provided in Level 0 and represents a home page. By way of example, box 200 “0-01” corresponds to home page of a global hub.

Boxes 210, 212, 214, and 216 are provided in Level 1 and represent a set of authorized forums. By way of example, box 210 “1-x” corresponds to learning forum web page. Likewise, box 212 “1-(x+1)” corresponds to Online assessment test forum web page. Box 214 “1-(x+2)” corresponds to Online notebook forum webpage and box 216 “1-(x+3)” corresponds to Museum forum web page and so on.

Boxes 250, 252, and 254 are provided in Level 2 and represent pages dedicated to a particular authorized forum. For example, box 250 “2-x” corresponds to web page 210. Boxes 270, and 272 are provided in Level 3 and represent web pages that may be accessed from a Level 2 box.

Navigation downward through web tree 200 is provided by way of selecting hyperlinks from a directory or subdirectory listing, such as between Levels 1 to 2. Once the user enters a web page that is part of a desired subset, which is schematically illustrated as level 3, the user strolls between related pages. The user is confined by way of the stroll control buttons, such that the user may not unknowingly be lost in an undesired forum.

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

While, the following description is presented to enable a person of ordinary skill in the art to make and use the invention and is provided in the context of the requirement for obtaining a patent, the present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features.

Accordingly, the present invention is not intended to be limited to the embodiment shown but is to be accorded the widest scope consistent with the principles and features described herein.

Many modifications of the present invention will be apparent to those skilled in the art to which the present invention applies. Further, it may be desirable to use some of the features of the present invention without the corresponding use of other features. Accordingly, the foregoing description of the present invention should be considered as merely illustrative of the principles of the present invention and not in limitation thereof.

What is claimed is:

1. A method for navigating data through a set of authorized forums via a authenticating the website using an identifying module by a user; viewing one of the set of authorized forum from the displayed set of authorized forums by an authenticated user; and selecting one of the authorized forums by navigating the website by the authenticated user.

2. The method according to claim 1, wherein authenticating the website includes a set of techniques or the like using the identifying module.

3. The method according to claim 2, wherein authenticating the website with the set of techniques includes a biometric technique or a finger print technique or a speech technique or an image technique or the like or the combination thereof.

4. The method according to claim 1, wherein viewing the website by the authenticated user via a 3D or 2D technique or the like.

5. The method according to claim 1, further comprises setting up a server in a computer network with the server using the displayed set of authorized forums.

6. The method according to claim 5, wherein the computer network adheres to an internet protocol.

7. The method according to claim 5, wherein the server comprises; a plurality of web servers; a plurality of application servers, each of which is connected to the plurality of web servers; a file server connected between a database and each of the plurality of application servers; and

8. The method according to claim 1, wherein the displayed set of the authorized forums includes an online innovation station forum or a translation forum or a hall of fame forum or a learning forum or a museum forum or an online social network forum or an online notebook forum or an online assessment test forum or a research work forum or an entertainment forum or a shopping forum or a health section forum or the like or the combination thereof.
